(19) United States
(12) Patent Application Publication
(10) Pub. No.: US 2012/0139728 A1
(43) Pub. Date: Jun. 7, 2012

(54) INTRUSION DETECTING SYSTEM

(75) Inventors: Jun FUJIWARA, Tokyo (JP); Hideyuki Orita, Tokyo (JP)

(73) Assignee: MITSUBISHI ELECTRIC CORPORATION, Chiyoda-ku (JP)

(21) Appl. No.: 13/195,945

(22) Filed: Aug. 2, 2011

(30) Foreign Application Priority Data
Dec. 6, 2010 (JP) 2010-271377

(51) Int. Cl. G08B 13/26

(52) U.S. Cl. 340/561

(57) ABSTRACT

A space required to locate a leakage coaxial transmission path so as to suppress false detection is reduced, and a target range where the intrusion detecting system is available is enlarged. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, wherein at least one of the transmitter leakage transmission path and the receiver leakage transmission path is a surface wave leakage coaxial transmission path.

### BACKGROUND OF THE INVENTION

1. Technical Field

The present invention relates to an intrusion detecting system that detects the presence or absence of an intrusion object such as a person and an intrusion position with the use of a leakage coaxial transmission path.

2. Background Art

In the intrusion detecting device using the leakage coaxial transmission path, with the use of a transmitter leakage coaxial cable and a receiver leakage coaxial cable, a signal is transmitted from the transmitter cable, and the presence or absence of the intrusion object and the intrusion position are determined according to a change in the signal received by the receiver cable.

In a related-art wide-area intrusion detecting system using the leakage coaxial transmission path, the transmitter cable and the receiver cable are placed on or in the ground in parallel to each other in use (for example, refer to JP-A-2009-252020 (FIG. 7), JP-A-Hei-5(1993)-143877 (FIG. 1), JP-A-Hei-6(1994)-222153 (FIG. 1), and JP-A-Hei-9(1997)-292460 (FIG. 1)).

In the related-art wide-area intrusion detecting system using the leakage coaxial transmission path, the transmitter leakage coaxial cable and the receiver leakage coaxial cable must be placed on or in the ground in parallel to each other. Also, in order to realize a monitor distance of a given specification, there is a need to ensure that an interval between those cables is at least 80 cm or larger. When the interval is 80 cm or smaller, although the installation area is reduced, a portion where the receive level is too high occurs. This leads to such an adverse effect that an output of transmit radio waves must decrease, and a maximum value of the monitor distance in a longitudinal direction of the cables is shortened. Also, in order to avoid the disturbance of radio waves such as the reflection or scatter of radio waves due to the surrounding environment, which is caused by a factor other than an intruder and induces false detection, there is a need to ensure a space of about 50 cm to several m in length outside those cables. Accordingly, in order for the intrusion monitoring device using the leakage coaxial transmission path to provide a normal detection performance, a space area (an area in which there is nothing such as a structure and a passing vehicle on a site) which is 2 m or longer, or 5 in or longer depending on the environment, in a transverse direction, is required as a space in which the leakage coaxial transmission path is placed. As a result, when the leakage coaxial transmission path is placed on an outer periphery of the existing site, there is a case in which a sufficient installation area cannot be ensured, and the leakage coaxial transmission path cannot be introduced. This is a problem to be preferably improved.

### SUMMARY OF THE INVENTION

The present invention has been made to solve the above problem, and aims at reducing a space required to place the leakage coaxial transmission path so as to suppress false detection, and enlarging a range where the intrusion monitoring system is available.

According to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein at least one of the transmitter leakage transmission path and the receiver leakage transmission path is a surface wave leakage coaxial transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein at least one of the transmitter leakage transmission path and the receiver leakage transmission path is a surface wave leakage coaxial transmission path,

wherein one of the transmitter leakage transmission path and the receiver leakage transmission path extends at a lower side of a plurality of windows arranged laterally in a building over the plurality of windows,

wherein the other of the transmitter leakage transmission path and the receiver leakage transmission path extends at an upper side of the plurality of windows over the plurality of windows, and

wherein the intrusion detecting device detects from which of the plurality of windows the intrusion object intrudes on the basis of the change in the detection signal, which is received by the receive leakage transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein at least one of the transmitter leakage transmission path and the receiver leakage transmission path is a surface wave leakage coaxial transmission path,

wherein one of the transmitter leakage transmission path and the receiver leakage transmission path extends at a left side of a plurality of windows arranged longitudinally in a building over the plurality of windows,

wherein the other of the transmitter leakage transmission path and the receiver leakage transmission path extends at a right side of the plurality of windows over the plurality of windows, and

wherein the intrusion detecting device detects from which of the plurality of windows the intrusion object intrudes on the basis of the change in the detection signal, which is received by the receive leakage transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein one of the transmitter leakage transmission path and the receiver leakage transmission path extends at a left side of a plurality of windows arranged longitudinally in a building over the plurality of windows,

wherein the other of the transmitter leakage transmission path and the receiver leakage transmission path extends at a right side of the plurality of windows over the plurality of windows,

wherein a height of a lower window of the plurality of windows is equivalent to a height of the intrusion object,

wherein both of the transmitter leakage transmission path and the receiver leakage transmission path at both of right and left sides of the lower window are surface wave leakage coaxial transmission paths,

wherein both of the transmitter leakage transmission path and the receiver leakage transmission path at both of right and left sides of a window upper than the lower window are radiation leakage coaxial transmission paths, and

wherein the intrusion detecting device detects from which of the plurality of windows the intrusion object intrudes on the basis of the change in the detection signal, which is received by the receive leakage transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein both of the transmitter leakage transmission path and the receiver leakage transmission path are surface wave leakage coaxial transmission paths,

wherein one of the transmitter leakage transmission path and the receiver leakage transmission path extends at one side of a passage inlet,

wherein the other of the transmitter leakage transmission path and the receiver leakage transmission path extends at the other side of the passage path with respect to the inlet, and

wherein the intrusion detecting device detects that the intrusion object intrudes from the passage inlet on the basis of the change in the detection signal, which is received by the receiver leakage transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein one of the transmitter leakage transmission path and the receiver leakage transmission path extends at one side of a passage inlet,

wherein the other of the transmitter leakage transmission path and the receiver leakage transmission path extends at the other side of the passage path with respect to the inlet,

wherein in an area where a height of the leakage transmission paths at both sides of the passage inlet is equal to a height of the intrusion object, both of the leakage transmission paths at both sides thereof are surface wave leakage coaxial transmission paths,

wherein in an area where a height of the leakage transmission paths at both sides of the passage inlet is equivalent to or higher than the height of the intrusion object, both of the leakage transmission paths at both sides are radiation leakage coaxial transmission paths, and

wherein the intrusion detecting device detects that the intrusion object intrudes from the passage inlet on the basis of the change in the detection signal, which is received by the receive leakage transmission path.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein the transmitter leakage transmission path and the receiver leakage transmission path are placed at an intrusion detection region side of a wall close to the wall, and

wherein both of the transmitter leakage transmission path and the receiver leakage transmission path are surface wave leakage coaxial transmission paths.

Also, according to the present invention, there is provided an intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein each of the transmitter leakage transmission path and the receiver leakage transmission path is configured by coupling a plurality of the leakage coaxial transmission paths,

wherein in the transmitter leakage transmission path and the receiver leakage transmission path each configured by coupling the plurality of the leakage coaxial transmission paths, the leakage transmission paths adjacent to the passage are surface wave leakage coaxial transmission paths, and

wherein the leakage transmission paths other than the leakage transmission paths adjacent to the passage are radiation leakage coaxial transmission paths.

According to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, at least one of the transmitter leakage transmission path and the receiver leakage transmission path is a surface wave leakage coaxial transmission path. Therefore, even if a space required for placing the leakage coaxial transmission path is reduced, false detection can be suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, at least one of the transmitter leakage transmission path and the receiver leakage transmission path is a surface wave leakage coaxial transmission path, one of the transmitter leakage transmission path and the receiver leakage transmission path extends at a lower side of a plurality of windows arranged laterally in a building over the plurality of windows, the other of the transmitter leakage transmission path and the receiver leakage transmission path extends at an upper side of the plurality of windows over the plurality of windows, and the intrusion detecting device detects from which of the plurality of windows the intrusion object intrudes on the basis of the change in the detection signal, which is received by the receive leakage transmission path. Therefore, even if a space required for placing the leakage coaxial transmission path is reduced, false detection can he suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, at least one of the transmitter leakage transmission path and the receiver leakage transmission path is a surface wave leakage coaxial transmission path, one of the transmitter leakage transmission path and the receiver leakage transmission path extends at a left side of a plurality of windows arranged longitudinally in a building over the plurality of windows, the other of the transmitter leakage transmission path and the receiver leakage transmission path extends at a right side of the plurality of windows over the plurality of windows, and the intrusion detecting device detects from which of the plurality of windows the intrusion object intrudes on the basis of the change in the detection signal, which is received by the receive leakage transmission path. Therefore, even if a space required for placing the leakage coaxial transmission path is reduced, false detection can be suppressed, and the leakage coaxial transmission path can be placed in an area where the leakage coaxial transmission path could not be placed up to now

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, one of the transmitter leakage transmission path and the receiver leakage transmission path extends at a left side of a plurality of windows arranged longitudinally in a building over the plurality of windows, the other of the transmitter leakage transmission path and the receiver leakage transmission path extends at a right side of the plurality of windows over the plurality of windows, a height of a lower window of the plurality of windows is equivalent to a height of the intrusion object, both of the transmitter leakage transmission path and the receiver leakage transmission path at both of right and left sides of the lower window are surface wave leakage coaxial transmission paths, both of the transmitter leakage transmission path and the receiver leakage transmission path at both of right and left sides of a window upper than the lower window are radiation leakage coaxial transmission paths, and the intrusion detecting device detects from which of the plurality of windows the intrusion object intrudes on the basis of the change in the detection signal, which is received by the receive leakage transmission path. Therefore, even if a space required for placing the leakage coaxial transmission path is reduced, false detection can be suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, both of the transmitter leakage transmission path and the receiver leakage transmission path are surface wave leakage coaxial transmission paths, one of the transmitter leakage transmission path and the receiver leakage transmission path extends at one side of a passage inlet, the other of the transmitter leakage transmission path and the receiver leakage transmission path extends at the other side of the passage path with respect to the inlet, and the intrusion detecting device detects that the intrusion object intrudes from the passage inlet on the basis of the change in the detection signal, which is received by the receiver leakage transmission path. Therefore, even if a space required for placing the leakage coaxial transmission path is reduced, false detection can be suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, one of the transmitter leakage transmission path and the receiver leakage transmission path extends at one side of a passage inlet, the other of the transmitter leakage transmission path and the receiver leakage transmission path extends at the other side of the passage path with respect to the inlet, in an area where a height of the leakage transmission paths at both sides of the passage inlet is equal to a height of the intrusion object, both of the leakage transmission paths at both sides thereof are surface wave leakage coaxial transmission paths, in an area where a height of the leakage transmission paths at both sides of the passage inlet is equivalent to or higher than the height of the intrusion object, both of the leakage transmission paths at both sides are radiation leakage coaxial transmission paths, and the intrusion detecting device detects that the intrusion object intrudes from the passage inlet on the basis of the change in the detection signal, which is received by the receive leakage transmission path. Therefore, even if a space required for placing the leakage coaxial transmission path is reduced, false detection can be suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, the transmitter leakage transmission path and the receiver leakage transmission path are placed at an intrusion detection region side of a wall close to the wall, and both of the transmitter leakage transmission path and the receiver leakage transmission path are surface wave leakage coaxial transmission paths. Therefore, even if a space required for placing the leakage coaxial transmission path is reduced, false detection can be suppressed, and the leakage coaxial transmission path can be placed in an area where the leakage coaxial transmission path could not be placed up to now.

Also, according to the present invention, in the intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path, each of the transmitter leakage transmission path and the receiver leakage transmission path is configured by coupling a plurality of the leakage coaxial transmission paths, in the transmitter leakage transmission path and the receiver leakage transmission path each configured by coupling the plurality of the leakage coaxial transmission paths, the leakage transmission paths adjacent to the passage are surface wave leakage coaxial transmission paths, and the leakage transmission paths other than the leakage transmission paths adjacent to the passage are radiation leakage coaxial transmission paths. Therefore, even if a space required for placing the leakage coaxial transmission path is reduced, false detection can be suppressed, and the leakage coaxial transmission path can be placed in an area where the leakage coaxial transmission path could not be placed up to now.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram illustrating a case of a rough configuration of an intrusion detecting system according to a first embodiment Of the present invention;

FIG. 2 is a diagram illustrating an example of a detection concept of an intrusion position according to the first embodiment of the present invention;

FIG. 3 is a diagram illustrating a specific example of a transmit signal according to the first embodiment of the present invention;

FIG. 4 is a block diagram illustrating an example of an internal configuration of an intrusion detecting device according to the first embodiment of the present invention;

FIG. 5A is a diagram illustrating a conventional intrusion detecting system, FIG. 5B is a diagram illustrating a conventional intrusion detecting system of another simplification type, and FIG. 5C is a diagram illustrating an intrusion detecting system according to the first embodiment of the present invention;

FIG. 6A is a diagram illustrating the invention made in a process of reaching the present invention, and FIG. 6B is a diagram illustrating another example of the intrusion detecting system according to a second embodiment of the present invention;

FIG. 7 is a diagram illustrating still another example of the intrusion detecting system according to a third embodiment of the present invention;

FIG. 8 is a diagram illustrating still another example of the intrusion detecting system according to a fourth embodiment of the present invention;

FIG. 9 is a diagram illustrating still another example of the intrusion detecting system according to a fifth embodiment of the present invention;

FIG. 10 is a diagram illustrating still another example of the intrusion detecting system according to a sixth embodiment of the present invention;

FIG. 11 is a diagram illustrating still another example of the intrusion detecting system according to a seventh embodiment of the present invention;

FIG. 12A is a diagram illustrating a conventional intrusion detecting system, FIG. 12B is a diagram illustrating the invention made in a process of reaching the present invention, and FIG. 12C is a diagram illustrating still another example of the intrusion detecting system according to an eighth embodiment of the present invention;

FIG. 13 is a diagram illustrating still another example of the intrusion detecting system according to a ninth embodiment of the present invention;

FIG. 14 is a diagram illustrating still another example of the intrusion detecting system according to a tenth embodiment of the present invention;

FIG. 15 is a diagram illustrating still another example of the intrusion detecting system according to an eleventh embodiment of the present invention;

FIG. 16A is a diagram illustrating the invention made in a process of reaching the present invention, and FIG. 16B is a diagram illustrating still another example of the intrusion detecting system according to a twelfth embodiment of the present invention;

FIG. 17A is a diagram illustrating the invention made in a process of reaching the present invention, and FIG. 17B is a diagram illustrating still another example of the intrusion detecting system according to a thirteenth embodiment of the present invention;

FIG. 18 is a diagram illustrating still another example of the intrusion detecting system according to a fourteenth embodiment of the present invention;

FIG. 19 is a diagram illustrating still another example of the intrusion detecting system according to a fifteenth embodiment of the present invention; and

FIG. 20 is a diagram illustrating still another example of the intrusion detecting system according to a sixteenth embodiment of the present invention.

### DETAILED DESCRIPTION OF THE PREFERRED EMBODIMENTS

### First Embodiment

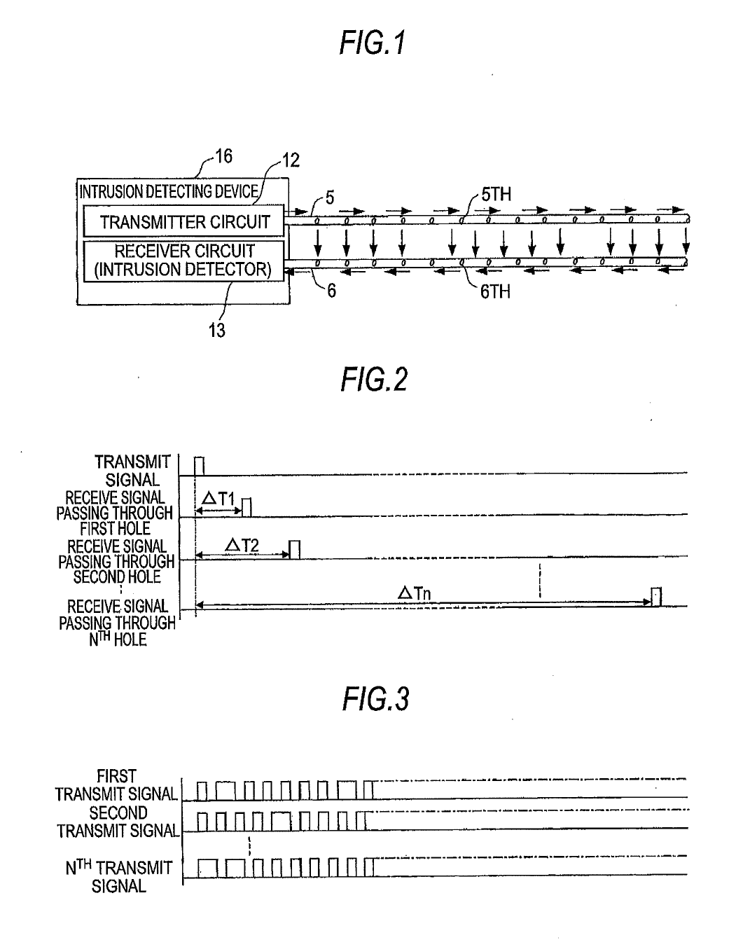

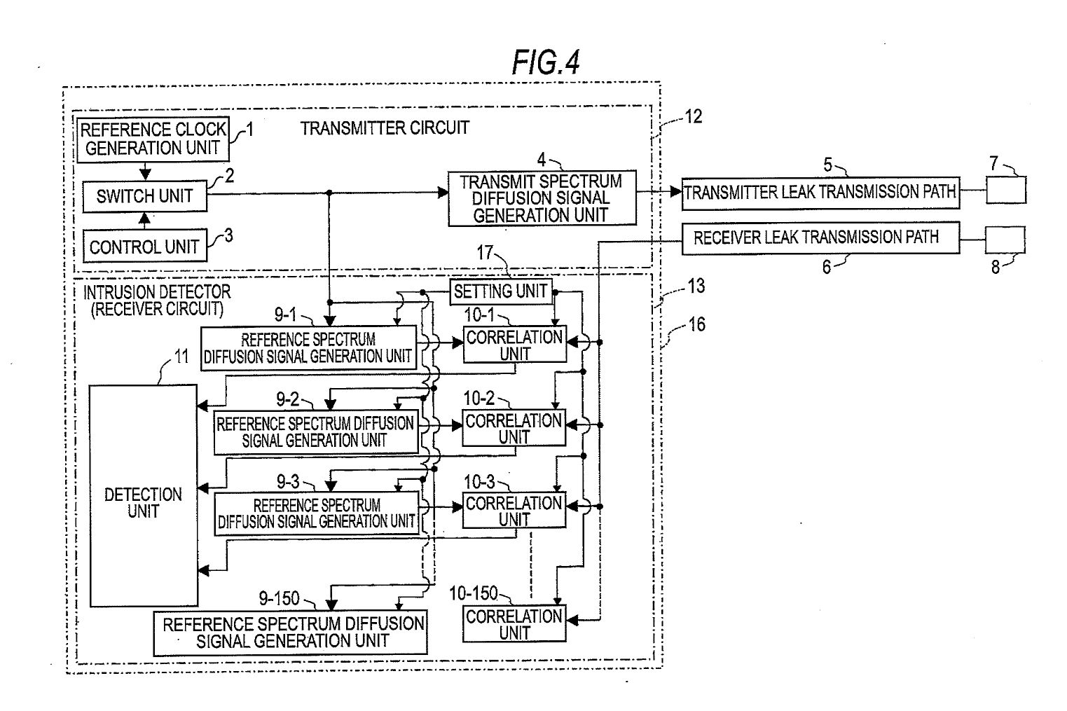

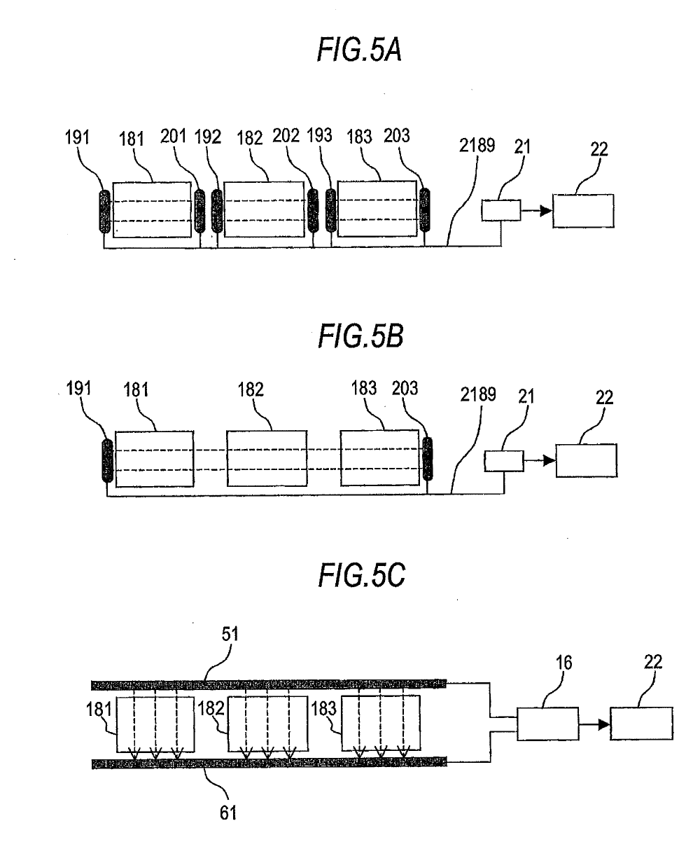

Hereinafter, a first embodiment of the present invention will be described with reference to FIGS. 1 to 5. FIG. 1 is a diagram illustrating a case of a rough configuration of an intrusion detecting system according to a first embodiment of the present invention. FIG. 2 is a diagram illustrating an example of a detection concept of an intrusion position according to the first embodiment of the present invention. FIG. 3 is a diagram illustrating a specific example of a transmit signal according to the first embodiment of the present invention. FIG. 4 is a block diagram illustrating an example of an internal configuration of an intrusion detecting device according to the first embodiment of the present invention. FIG. 5A is a diagram illustrating a conventional intrusion detecting system, FIG. 5B is a diagram illustrating a conventional intrusion detecting system of another simplification type, and FIG. 5C is a diagram illustrating an intrusion detecting system according to the first embodiment of the present invention.

First, the operational principle according to the first embodiment of the present invention will be described with reference to FIGS. 1 to 4.

FIG. 1 illustrates an intrusion detecting system in which an intrusion detecting device 16 is connected with a transmitter leakage transmission path 5 and a receiver leakage transmission path 6 that is disposed in parallel to the transmitter leakage transmission path 5, and receives a leakage radio wave from the transmitter leakage transmission path 5. The intrusion detecting device 16 determines that there is an intruder if the radio wave received by the receiver leakage transmission path 6 changes. The transmitter leakage transmission path 5 and the receiver leakage transmission path 6, which are paired with each other, have a plurality of leakage portions 5TH and 6TH scattered along a direction of extending the leakage transmission paths, respectively. The transmitter leakage transmission path 5 and the receiver leakage transmission path 6 each have an intrusion position detection function for detecting an intrusion position of the intruder according to a state of each receive signal in a receiver circuit 13 at the receiver side due to the leakage radio waves at the respective leakage portions 5TH and 6TH.

The transmitter leakage transmission path 5 and the receiver leakage transmission path 6 are formed of, for example, commercially available leakage coaxial cables. The leakage portions 5TH and 6TH of the transmitter leakage transmission path 5 and the receiver leakage transmission path 6 are penetration slots that penetrate envelops of the cables at intervals of several meters in the commercially available leakage coaxial cables.

Now, an example of a detection concept of the intrusion positions will be exemplified.

The commercially available leakage coaxial cables are used as the transmitter leakage transmission path 5 and the receiver leakage transmission path 6. The transmitter leakage transmission path 5 and the receiver leakage transmission path 6 are placed at intervals of several meters. For example, one transmit pulse is transmitted from the transmitter circuit 12 as illustrated in FIG. 2. In this case, the leakage radio wave from a first (initial) hole (penetration slot) of the transmitter leakage transmission path 5 is received through a first (initial) hole (penetration slot) of the receiver leakage transmission path 6, and arrives at the intrusion detector 13, which is the receiver circuit, as a receive signal. An arrival time of the leakage radio wave is ΔT1 after the transmit signal is transmitted.

Likewise, when one transmit pulse is transmitted from the transmitter circuit 12, the leakage radio wave from a second hole of the transmitter leakage transmission path 5 is received through a second hole of the receiver leakage transmission path 6, and arrives at the intrusion detector 13, which is the receiver circuit, as a receive signal. An arrival time of the leakage radio wave is ΔT2 after the transmit signal is transmitted.

Likewise, the arrival time of the receive signal through a third hole is ΔT3 after the transmit signal is transmitted. The arrival times ΔT1, ΔT2, ΔT3 . . . , that is, the arrival time (also called “delay time”) ΔT is easily obtained through computation if a length of the signal transmission path is found since a propagation velocity of the signal is 300,000 km/sec.

Accordingly, in the intrusion detector 13, if data of the arrival time (delay time) ΔT computed according to a system configuration in advance is saved, it is possible to discriminate which hole (penetration slot) the receive signal has passed through by matching the received real receive signal to the saved data.

Also, when a person intrudes into a region where the leakage radio wave exists, the leakage radio wave is changed, for example, a shape thereof is changed, due to the intruder.

Accordingly, when a change in the signal received by the intrusion detector 13 is detected, it is possible to detect and announce into which position the leakage radio wave intrudes along the transmitter leakage transmission path 5 and the receiver leakage transmission path 6.

Since the signal speed is extremely high, from a relationship with the detecting operation speed of the receiver circuit, in fact, a single pulse is not transmitted about once per several seconds as the transmit signal. If a spectrum diffusion signal called “PN code” as exemplified in FIG. 3, for example, a coded signal including, for example, several ten thousands random pulse strings is used, a detection precision can be enhanced. An identical PN code may be repetitively transmitted, or different PN codes may be sequentially transmitted. The PN code per se is a generally known code.

When the PN code is used in the intrusion detecting system exemplified in FIG. 1, the intrusion detecting device 16 modulates a carrier of a high frequency wave in phase by an output of the transmitter circuit 12 that generates a spectrum diffusion signal, and outputs the modulated carrier to the transmitter leakage transmission path 5. The radio wave output from the transmitter leakage transmission path 5 is received by the receiver leakage transmission path 6 through the leakage portion, and received by the intrusion detector 13. In the intrusion detector 13, the received radio wave is computed in phase with a reference spectrum diffusion code associated with an intrusion distance, and the intruder corresponding to the intrusion distance is detected by a change in the electric field intensity.

In the intrusion detecting system having the transmitter leakage transmission path 5 and the receiver leakage transmission path 6 that is disposed in parallel to the transmitter leakage transmission path 5, and determining that there is an intruder if the radio wave received by the receiver leakage transmission path 6 changes, in the experiment and research by the present inventors, it is found that the leakage transmission paths 5 and 6 are placed in the length of about 1500 to 3000 m, the presence or absence of intrusion of a human in between the leakage transmission paths 5 and 6, and the intrusion position can be detected over a long distance of about 1500 to 3000 m. The intrusion detector 13 is configured by a product form of a sensor card in which an intrusion detecting function is mounted on a substrate into a module. The intrusion detector 13 can address a distance to be detected, for example, 1000 m, 1500 m, and 2000 m by increasing the number of sensor cards.

Referring to FIG. 4, the transmitter circuit 12 includes a reference clock generation unit 1, a switch unit 2, a control unit 3, and a transmit spectrum diffusion signal generation unit 4. The intrusion detection unit 13 includes a detection unit 11, reference spectrum diffusion signal generation units 9-1 to 9-150, and correlation units 10-1 to 10-150. For example, it is assumed that a distance of 3000 m with a precision of 20 m is a detection range in a cable extending direction. The transmitter leakage transmission path 5 transmit a transmit spectrum diffusion signal. A transmitter terminator 7 prevents the occurrence of an error caused by reflection of the transmit spectrum diffusion signal. The receiver leakage transmission path 6 receives the transmit spectrum diffusion signal, and transmits the signal. A receiver terminal 8 receives the transmission spectrum diffusion signal, and prevents the occurrence of an error caused by reflection of the transmit spectrum diffusion signal.

Also, the intrusion detection unit 13 includes a setting unit 17. On the basis of setting, the setting unit 17 stops and starts the functions of the respective reference spectrum diffusion signal generation units 9-1 to 9-150, individually. Also, the setting unit 17 stops and starts the functions of the respective correlation units 10-1 to 10-150, individually. Accordingly, with the setting of the setting unit 17, an intrusion detection precision, and an intrusion detection distance (a detectable distance in a direction of extending the leakage transmission path) can be arbitrarily selectively set.

Also, the intrusion detecting device 16 also called “obstacle detecting device” is roughly made up of the transmitter circuit 12 and the intrusion detector 13.

Subsequently, the operation in FIG. 4 will be described.

A reference diffusion code of the delay time at measurement distance 10 m (±5 m) intervals of the intruder by the plurality of reference spectrum diffusion signal generation units 9-1 to 9-150 is generated from the reference clock generation unit 1. The reference spectrum diffusion signal diffused and modulated by the reference diffusion code is output. The correlations between the transmission spectrum diffusion signals received by the receiver leakage transmission path 6 and the reference spectrum diffusion signals are taken by 150 correlation means 10-1 to 10-150 corresponding to the reference spectrum diffusion signal generation units 9-1 to 9-150. When the phase matches each other, a correlation signal is output. When the variation of the signal level of the correlation signal to each specific delay time set in the reference spectrum diffusion signal generation units 9-1 to 9-150 is a set value or higher, the detection unit 11 detects that the intruder exists in an area of 10 m (±5 m) intervals within a site such as factories or rails.

In the above first embodiment, with mounting of the 150 reference spectrum diffusion signal generation units 9-1 to 9-150 setting the delay times corresponding to the measurement distance 10 m (±5 m) intervals, and mounting of the 150 correlation units 10-1 to 10-150 corresponding to those generation units, the detection distance can be set to 150 (the number of correlations)×10 m (±5 m) (detection distance) 1500 m while the detection precision ±5 m is maintained by one intrusion detecting device. Thus, the economically excellent wide-range intrusion detecting device 16 can be obtained.

Hereinafter, an example of the intrusion detecting system according to the first embodiment of the present invention illustrated in FIG. 50 will be described as compared with the conventional intrusion detecting system illustrated in FIG. 5A and the conventional intrusion detecting system of another simplification type illustrated in FIG. 5B.

In FIG. 5C exemplifying an example of the intrusion detecting system according to the first embodiment of the present invention, in an intrusion detecting system in which a transmitter leakage transmission path 51 that transmits a detection signal for detecting an intrusion and a receiver leakage transmission path 61 that receives the detection signal leaked from the transmitter leakage transmission path are installed apart from each other within an intrusion monitor area, and an intrusion detecting device 16 detects presence or absence of an intrusion object in the intrusion monitor area on the basis of a change in the detection signal received by the receiver leakage transmission path 61, at least one of the transmitter leakage transmission path 51 and the receiver leakage transmission path 61 is a surface wave leakage coaxial transmission path. More specifically, in an intrusion detecting system in which a transmitter leakage transmission path 51 that transmits a detection signal for detecting an intrusion and a receiver leakage transmission path 61 that receives the detection signal leaked from the transmitter leakage transmission path are installed apart from each other within an intrusion monitor area, and an intrusion detecting device 16 detects presence or absence of an intrusion object in the intrusion monitor area on the basis of a change in the detection signal received by the receiver leakage transmission path 61, at least one of the transmitter leakage transmission path 51 and the receiver leakage transmission path 61 is a surface wave leakage coaxial transmission path, one 61 of the transmitter leakage transmission path 51 and the receiver leakage transmission path 61 extends at a lower side of a plurality of windows 181, 182, and 183 arranged laterally in a building over the plurality of windows 181, 182, and 183, and the other 51 of the transmitter leakage transmission path 51 and the receiver leakage transmission path 61 extends at an upper side of the plurality of windows 181, 182, and 183 over the plurality of windows 181, 182, and 183, and wherein the intrusion detecting device 16 detects from which of the plurality of windows 181, 182, and 183 the intrusion object intrudes on the basis of the change in the detection signal, which is received by the receiver leakage transmission path 61.

In FIG. 5A illustrating a case of the related art system that detects from which of the plurality of windows 181, 182, and 183 the intrusion object intrudes, an intrusion detection unit having a transmitter 191 and a receiver 201 of an infrared ray type, an intrusion detection unit having a transmitter 192 and a receiver 202 of an infrared ray type, and an intrusion detection unit having a transmitter 193 and a receiver 203 of an infrared ray type are disposed for the windows 181, 182, and 183, respectively. Moreover, a line for connecting the respective units and the intrusion detecting device 16 over the windows 181, 182, and 183 is required.

FIG. 5B illustrating the conventional system of the simplification type is of a simplification type in which the transmitter 191 of the infrared ray type is disposed at the left end of the window 181, the receiver 203 is disposed at the right end of the window 181, and the number of intrusion detecting units, and the number of lines can be reduced. However, it is impossible to detect from which of the plurality of windows 181, 182, and 183 the intrusion object intrudes cannot be detected.

On the contrary, in FIG. 5C exemplifying an example of the intrusion detecting system according to the first embodiment of the present invention, one leakage transmission path 61 of the transmitter leakage transmission path 51 and the receiver leakage transmission path 61 is arranged at a lower side of the plurality of windows 181, 182, and 183 disposed laterally on a building over the plurality of windows 181, 182, and 183. The other leakage transmission path 51 of the transmitter leakage transmission path 51 and the receiver leakage transmission path 61 is arranged at an upper side of the plurality of windows 181, 182, and 183 disposed over the plurality of windows 181, 182, and 183. With this configuration, no line over the windows 181, 182, and 183 as in the related art system is required. Moreover, it is possible to detect from which window of the plurality of windows 181, 182, and 183 the intrusion object intrudes.

### Second Embodiment

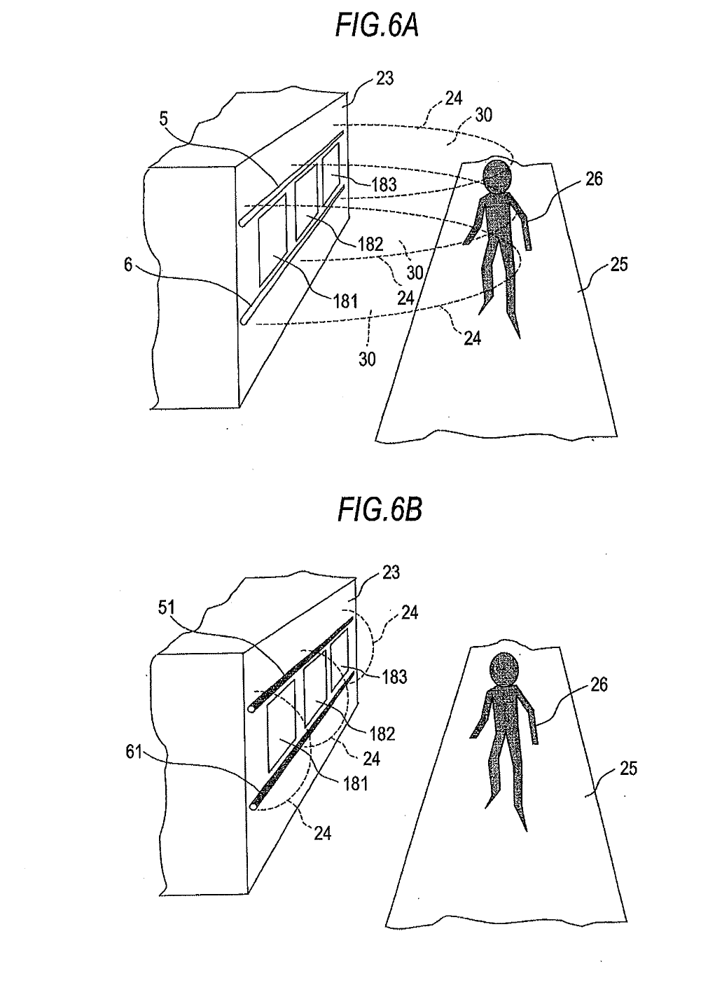

Hereinafter, a second embodiment will be described with reference to FIGS. 6A and 6B. An example of a specific intrusion detecting system targeting a plurality of windows in a building at the side of a passage in FIG. 6B is compared with the invention made in a process of reaching the present invention in FIG. 6A.

The leakage coaxial cable which is a representative case of the leakage transmission path is of two types of the radiation type and the surface wave type. In a standard configuration of the intrusion detecting system using the leakage coaxial transmission path, the leakage coaxial cable of the radiation type is used. In the leakage coaxial cables of the radiation type and the surface wave type, the radio wave radiation characteristics in a short-side direction of the cable are different from each other. The radio wave intensity in the case of using the radiation type is inversely proportional to a distance from the leakage coaxial cable. The radio wave intensity of the surface wave type is exponentially reduced with respect to the distance from the leakage coaxial cable. Accordingly, a detection area in the case of using the leakage coaxial cable of the surface wave type is smaller in all of the detection area height and the detection area width including the detection area width outside the leakage coaxial cable than the detection area height and the detection area width of the radiation leakage coaxial cable. That is, the detection area in the case of using the surface wave leakage coaxial cable is smaller than the detection area in the case of using the radiation leakage coaxial cable.

The invention made in a process of reaching the present invention in FIG. 6A is a case using the radiation leakage coaxial cable, and the second embodiment of the present invention in FIG. 6B is a case using the surface wave leakage coaxial cable.

As illustrated in FIGS. 6A and 6B, in the invention made in a process of reaching the present invention in FIG. 6A, an area 24 of the radiation leakage coaxial transmission paths 5 and 6 extending toward an upper side and a lower side of the plurality of windows 181, 182, and 183 over the plurality of windows 181, 182, and 183 arranged laterally on a first floor of a building 23 at the side of a passage 25, facing the passage 25 is high in the detection area height. Therefore, a person 26 walking on the passage 25 is falsely detected as an intruder from the windows 181, 182, and 183.

On the contrary, in the second embodiment of the present invention in FIG. 6B, an area 27 of the surface wave leakage coaxial transmission paths 51 and 61 extending toward an upper side and a lower side of the plurality of windows 181, 182, and 183 over the plurality of windows 181, 182, and 183 arranged laterally on the first floor of a building 23 at the side of a passage 25, and facing the passage 25 is narrower than the detection area 24 of the radiation leakage coaxial transmission paths 5 and 6. Therefore, no false detection is conducted unlike the radiation leakage coaxial transmission paths 5 and 6, without detecting the person 26 walking on the passage 25.

In the second embodiment of the present invention in FIG. 6B, the height of the plurality of windows 181, 182, and 183 is equivalent to the height of the intrusion object such as a person 26, and both of the transmitter leakage transmission path 51 and the receiver leakage transmission path 61 are the surface wave leakage coaxial transmission path. Also, both of the transmitter leakage transmission path 51 and the receiver leakage transmission path 61 are disposed outside of the building 23, and it is easy to, fit the transmitter leakage transmission path 51 and the receiver leakage transmission path 61 to the existing building 23.

### Third Embodiment

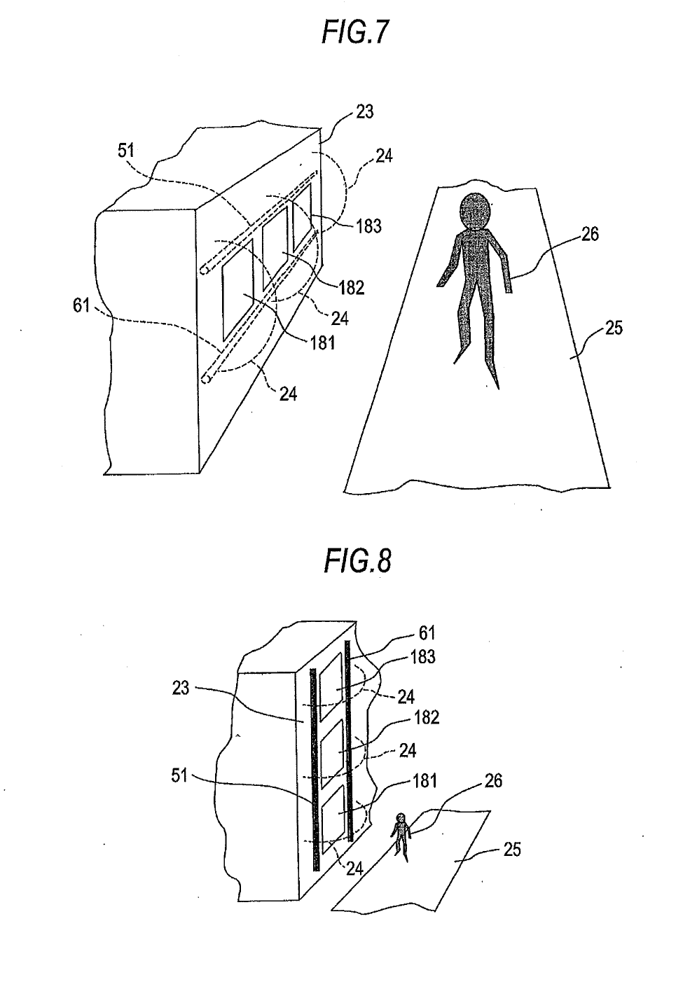

Hereinafter, a third embodiment of the present invention will be described with reference to FIG. 7.

As illustrated in FIG. 7, in the third embodiment of the present invention, both of the transmitter leakage transmission path 51 and the receiver leakage transmission path 61 are arranged inside the building 23.

Depending on the building, when the transmitter leakage transmission path 51 and the receiver leakage transmission path 61 are disposed outside the building 23 as illustrated in FIG. 6 described above, there is a possibility of interfering with the external appearance of the building. However, when both of the transmitter leakage transmission path 51 and the receiver leakage transmission path 61 are disposed inside the building 23 as illustrated in FIG. 7, the transmitter leakage transmission path 51 and the receiver leakage transmission path 61 do not interfere with the external building. Further, the transmitter leakage transmission path 51 and the receiver leakage transmission path 61 are not visible from the external of the building 23. Therefore, the installation of the intrusion detecting system using the transmitter leakage transmission path 51 and the receiver leakage transmission path 61 is not visible, and a confidential property of the existing intrusion detecting system is enhanced.

### Fourth Embodiment

Hereinafter, a fourth embodiment of the present invention will be described with reference to FIG. 8.

As exemplified in FIG. 8, in an intrusion detecting system in which a transmitter leakage transmission path 51 that transmits a detection signal for detecting an intrusion and a receiver leakage transmission path 61 that receives the detection signal leaked from the transmitter leakage transmission path are installed apart from each other within an intrusion monitor area, and an intrusion detecting device 16 detects presence or absence of an intrusion object in the intrusion monitor area on the basis of a change in the detection signal received by the receiver leakage transmission path 61,

wherein at least one of the transmitter leakage transmission path 51 and the receiver leakage transmission path 61 is a surface wave leakage coaxial transmission path,

wherein one 51 of the transmitter leakage transmission path 51 and the receiver leakage transmission path 61 extends at a left side of a plurality of windows 181, 182, and 183 arranged longitudinally in a building 23 over the plurality of windows 181, 182, and 183,

wherein the other 61 of the transmitter leakage transmission path 51 and the receiver leakage transmission path 61 extends at a right side of the plurality of windows 181, 182, and 183 over the plurality of windows 181, 182, and 183, and

wherein the intrusion detecting device 16 detects from which of the plurality of windows 181, 182, and 183 the intrusion object intrudes on the basis of the change in the detection signal, which is received by the receiver leakage transmission path 61. Both of the transmitter leakage transmission path 51 and the receiver leakage transmission path 61 are disposed outside the building 23, which obtains the same advantages as those described above in FIG. 6B.

### Fifth Embodiment

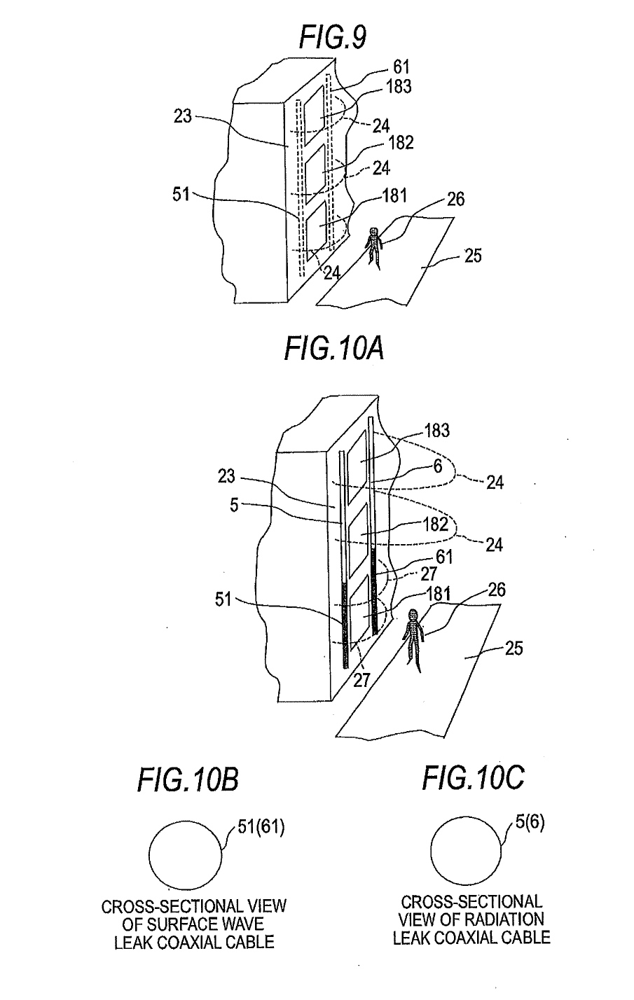

Hereinafter, a fifth embodiment of the present invention will be described with reference to FIG. 9.

As illustrated in FIG. 9, both of the transmitter leakage transmission path 51 and the receiver leakage transmission path 61 are arranged inside the building 23, and the others are identical with those described above in FIG. 7, which obtain the same advantages as those described above in FIG. 7.

### Sixth Embodiment

Hereinafter, a sixth embodiment of the present invention will be described with reference to FIGS. 10A to 10C.

As illustrated in FIG. 10A, in an intrusion detecting system in which a transmitter leakage transmission path 5, 51 that transmits a detection signal for detecting an intrusion and a receiver leakage transmission path 6, 61 that receives the detection signal leaked from the transmitter leakage transmission path 5, 51 are installed apart from each other within an intrusion monitor area, and an intrusion detecting device 16 detects presence or absence of an intrusion object in the intrusion monitor area on the basis of a change in the detection signal received by the receiver leakage transmission path 6, 61, one 5, 51 of the transmitter leakage transmission path 5, 51 and the receiver leakage transmission path 6, 61 extends at a left side of a plurality of windows 181, 182, 183 arranged longitudinally in a building over the plurality of windows 181, 182, 183, wherein the other 6, 61 of the transmitter leakage transmission path 5, 51 and the receiver leakage transmission path 6, 61. extends at a right side of the plurality of windows over the plurality of windows 181, 182, 183, a height of a lower window 181 of the plurality of windows 181, 182, 183 is equivalent to a height of the intrusion object such as a person 26, both of the transmitter leakage transmission path 51 and the receiver leakage transmission path 61 at both of right and left sides of the lower window 181 are surface wave leakage coaxial transmission paths, both of the transmitter leakage transmission path 5 and the receiver leakage transmission path 6 at both of right and left sides of the windows 182, 183 upper than the lower window 181 are radiation leakage coaxial transmission paths, and the intrusion detecting device 16 detects from which of the plurality of windows 181, 182, 183 the intrusion object intrudes on the basis of the change in the detection signal, which is received by the receiver leakage transmission path 6, 61.

Also, both of the transmitter leakage transmission path 5, 51 and the receiver leakage transmission path 6, 61 are disposed outside the building 23.

Since the surface wave leakage coaxial transmission path such as the surface wave leakage coaxial cable is more expensive than the radiation leakage coaxial transmission path such as the radiation leakage coaxial cable, when the height of the lower window 181 is equivalent to the height of the intrusion object such as the person 26 as in this embodiment, both of the transmitter leakage transmission path 51 and the receiver leakage transmission path 61 at both of right and left sides of the lower window 181 are the surface wave leakage coaxial transmission paths. Also, both of the transmitter leakage transmission path 5 and the receiver leakage transmission path 6 at both of right and left sides of the windows 182 and 183 upper than the lower window 181 are the radiation leakage coaxial transmission paths. In this case, the intrusion detecting system that does not falsely detect the person walking on the passage 25 can be configured inexpensively.

The cross section of the surface wave leakage coaxial cable is exemplified by FIG. 10B, and the cross section of the radiation leakage coaxial cable is exemplified in FIG. 10C. Since both of the surface wave leakage coaxial cable and the radiation leakage coaxial cable are commercially available, the surface wave leakage coaxial cable and the radiation leakage coaxial cable per se will be omitted from description.

### Seventh Embodiment

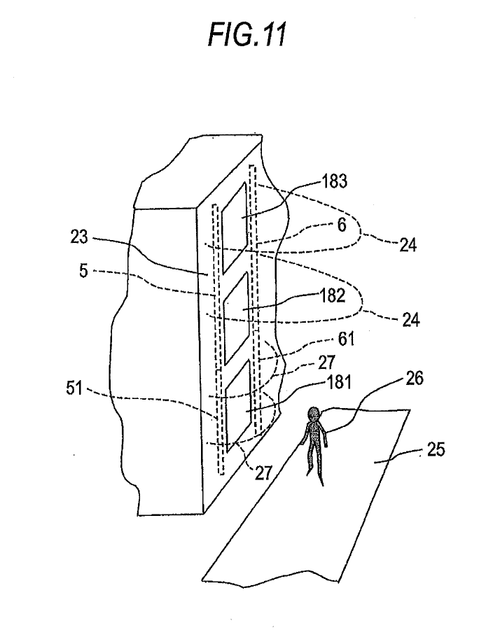

Hereinafter, a seventh embodiment of the present invention will be described with reference to FIG. 11.

As illustrated in FIG. 11, both of the transmitter leakage transmission path 5, 51 and the receiver leakage transmission path 6, 61 are arranged inside the building 23, and the others are identical with those described above in FIG. 10, which obtain the same advantages as those described above in FIGS. 9 and 10.

### Eighth Embodiment

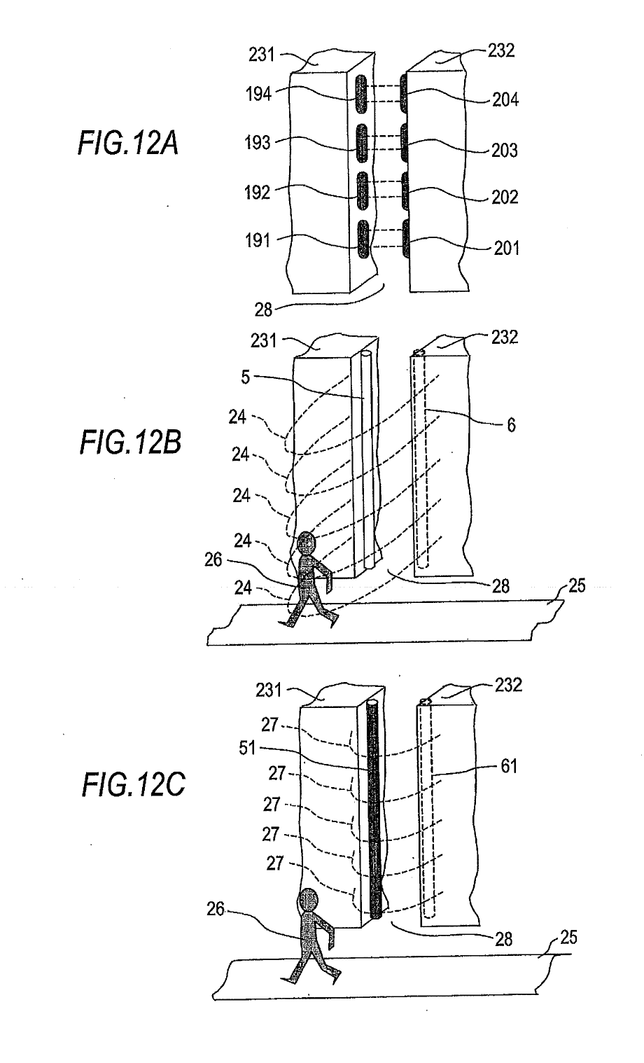

Hereinafter, an eighth embodiment of the present invention will be described with reference to FIGS. 12A to 12C.

As illustrated in FIG. 12C, in an intrusion detecting system in which a transmitter leakage transmission path 51 that transmits a detection signal for detecting an intrusion and a receiver leakage transmission path 61 that receives the detection signal leaked from the transmitter leakage transmission path 51 are installed apart from each other within an intrusion monitor area, and an intrusion detecting device 16 detects presence or absence of an intrusion object in the intrusion monitor area on the basis of a change in the detection signal received by the receiver leakage transmission path 61, both of the transmitter leakage transmission path 51 and the receiver leakage transmission path 61 are surface wave leakage coaxial transmission paths, one 51 of the transmitter leakage transmission path 51 and the receiver leakage transmission path 61 extends at one side (left side in this embodiment) of a passage inlet 28 between a building 231 and a building 232, or between a room 231 and a room 232, the other 61 of the transmitter leakage transmission path 51 and the receiver leakage transmission path 61 extends at the other side (right side in this embodiment) of the passage path 28 with respect to the inlet 28, and the intrusion detecting device 16 detects that the intrusion object intrudes from the passage inlet 28 on the basis of the change in the detection signal, which is received by the receiver leakage transmission path 61.

Also, both of the transmitter leakage transmission path 51 and the receiver leakage transmission path 61 are disposed outside a wall of the passage inlet 28.

In order to detect that the intrusion object intrudes from the passage inlet 28, for example, as exemplified in FIG. 12A, a plurality of detection units of the infrared ray system such as a detection unit having the transmitter 191 and the receiver 201 of the infrared ray system, and a detection unit having the transmitter 194 and the receiver 204 of the infrared ray system, may be disposed vertically. However, as described above, a large number of lines for connecting the respective units and the intrusion detecting device 21 are required.

Also, as illustrated in FIG. 12B, the general radiation transmitter leakage transmission path 5 and the general receiver leakage transmission path 6 may be installed. However, the radiation transmitter leakage transmission path 5 and the radiation receiver leakage transmission path 6 are relatively large in the detection area 24 as illustrated in FIG. 12B. Therefore, a person walking on a passage 25 crossing the passage inlet 28, for example, between the building 231 and the building 232, or between the room 231 and the room 232 is falsely detected.

On the contrary, in this embodiment illustrated in FIG. 12C, since the surface wave transmitter leakage transmission path 51 and the surface wave receiver leakage transmission path 61 are narrow in the detection area 27, the person walking on a passage 25 crossing the passage inlet 28, for example, between the building 231 and the building 232, or between the room 231 and the room 232 is not falsely detected.

### Ninth Embodiment

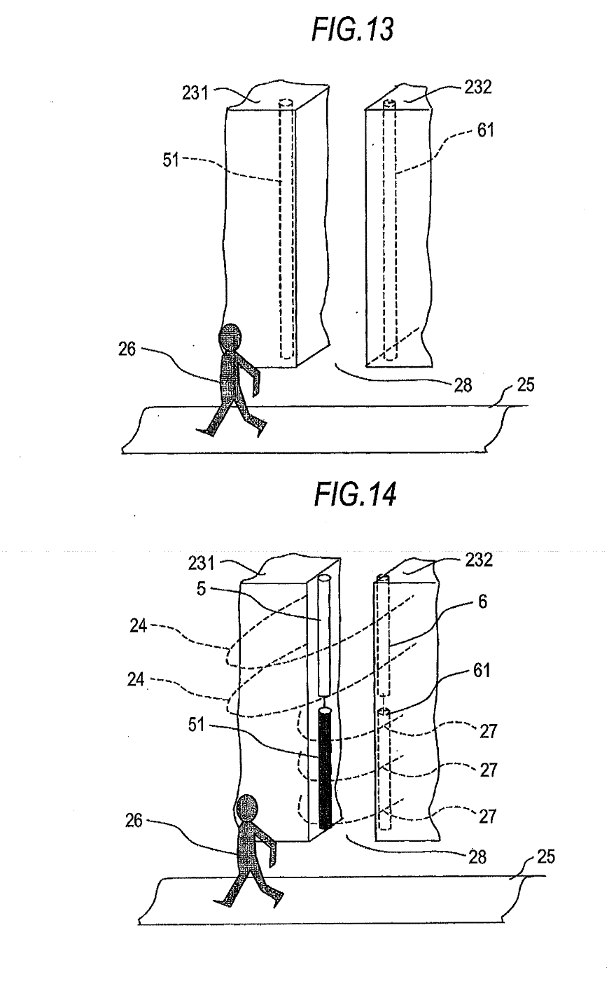

Hereinafter, a ninth embodiment of the present invention will be described with reference to FIG. 13.

As illustrated in FIG. 13, in the ninth embodiment, both of the transmitter leakage transmission path 51 and the receiver leakage transmission path 61 are disposed inside the buildings or the rooms 231 and 232 at both sides of the passage inlet 28, which obtain the same advantages as those described above in FIG. 120, and also obtain advantages of invisibility from the outside as described above in FIGS. 7, 9, and 11.

### Tenth Embodiment

Hereinafter, a tenth embodiment of the present invention will be described with reference to FIG. 14.

As illustrated in FIG. 14, in the tenth embodiment, in an intrusion detecting system in which a transmitter leakage transmission path 5, 51 that transmits a detection signal for detecting an intrusion and a receiver leakage transmission path 6, 61 that receives the detection signal leaked from the transmitter leakage transmission path are installed apart from each other within an intrusion monitor area, and an intrusion detecting device 16 detects presence or absence of an intrusion object in the intrusion monitor area on the basis of a change in the detection signal received by the receiver leakage transmission path 6, 61, one 5, 51 of the transmitter leakage transmission path 5, 51 and the receiver leakage transmission path 6, 61 extends vertically at one side (left side in this embodiment) of a passage inlet 28, the other 6, 61 of the transmitter leakage transmission path 5, 51 and the receiver leakage transmission path 6, 61 extends vertically at the other side (right side in this embodiment) of the passage path 28 with respect to the inlet 28, in an area where a height of the leakage transmission paths at both sides of the passage inlet 28 is equal to a height of the intrusion object, both of the leakage transmission paths 51, 61 at both sides thereof are surface wave leakage coaxial transmission paths, and in an area where a height of the leakage transmission paths at both sides of the passage inlet 28 is equivalent to or higher than the height of the intrusion object, both of the leakage transmission paths 5,6 at both sides are radiation leakage coaxial transmission paths, and the intrusion detecting device 16 detects that the intrusion object intrudes from the passage inlet 28 on the basis of the change in the detection signal, which is received by the receive leakage transmission path.

Also, both of the surface wave leakage coaxial transmission paths 51, 61 and the radiation leakage coaxial transmission paths 5, 6 are arranged outside buildings at both sides of the passage input inlet 28 or outside the walls of the rooms 231 and 232.

Accordingly, this embodiment has the same advantages and also has the effect from the viewpoints of the same costs as those in FIG. 10.

### Eleventh Embodiment

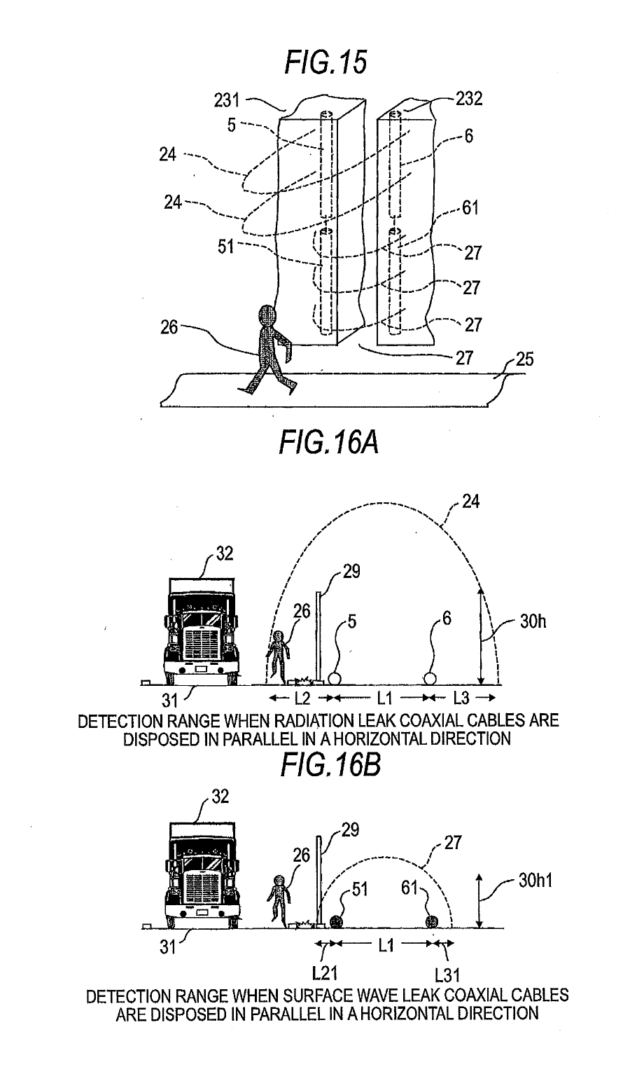

Hereinafter, an eleventh embodiment of the present invention will be described with reference to FIG. 15.

In the eleventh embodiment, as exemplified by FIG. 15, all of the surface wave leakage coaxial transmission paths 51, 61, and the radiation leakage coaxial transmission paths 5, 6 are disposed inside the walls of the buildings or the rooms 231, 232 at both sides of the passage inlet 28, which obtain the same advantages as those described above in FIG. 14, and also have the advantages of invisibility from the outside as described above in FIGS. 7, 9, 11, and 13.

### Twelfth Embodiment

Hereinafter, a twelfth embodiment of the present invention will be described with reference to FIGS. 16A and 16B.

In the twelfth embodiment, as exemplified in FIG. 16B, in an intrusion detecting system in which a transmitter leakage transmission path 51 that transmits a detection signal for detecting an intrusion and a receiver leakage transmission path 61 that receives the detection signal leaked from the transmitter leakage transmission path 51 are installed apart from each other within an intrusion monitor area, and an intrusion detecting device 16 detects presence or absence of an intrusion object in the intrusion monitor area on the basis of a change in the detection signal received by the receiver leakage transmission path 61, the transmitter leakage transmission path 51 and the receiver leakage transmission path 61 are placed at an intrusion detection region side of a wall 29 close to the wall 29, and both of the transmitter leakage transmission path 51 and the receiver leakage transmission path 61 are surface wave leakage coaxial transmission paths.

Also, a relative installation positional relationship between the transmitter leakage transmission path 51 and the receiver leakage transmission path 61 are a relationship in which the transmitter leakage transmission path 51 and the receiver leakage transmission path 61 are disposed in parallel to a horizontal direction along the fence 29.

When the relative installation positional relationship between the transmitter leakage transmission path and the receiver leakage transmission path are a relationship in which the transmitter leakage transmission path and the receiver leakage transmission path are disposed in parallel to a horizontal direction along the wall 29, as exemplified in FIG. 16A, an intrusion can be detected even when both of the transmitter leakage transmission path 5 and the receiver leakage transmission path 6 are the radiation leakage coaxial transmission paths. However, when both of the transmitter leakage transmission path 5 and the receiver leakage transmission path 6 are the radiation leakage coaxial transmission path, the detection area 24 is relatively large. Not only the detection height 30h is higher than the detection height 30h1 in the case of the surface wave leakage coaxial transmission paths 51 and 61 illustrated in FIG. 16B, but also the detection width is a width L1 between the leakage transmission paths 5 and 6, and detection widths L2 and L3 outside the leakage transmission paths 5 and 6, which is L1+L2+L3 in total. The total of the width L1 between the leakage transmission paths 51 and 61 in the case of the surface wave leakage coaxial transmission paths 51 and 61, and detection widths L21 and L31 outside the leakage transmission paths 51 and 61 is L1+L21+L31. A relationship between L1+L2+L3 and L1+L21+L31 becomes L1+L2+L3>L1+L21+L31. As illustrated in FIG. 16B, L2>L21 and L3>L31 are satisfied.

Accordingly, when the passage 31 is adjacent to the wall 29 at a side opposite to the intrusion detection region of the wall 29, there is a possibility that a person walking at the side of a vehicle 32 on the passage 31 enters the detection area 24, and false detection is conducted. The vehicle 32 may be falsely detected.

On the contrary, in this embodiment illustrated in FIG. 16B, since the detection widths L21 and L31 outside the leakage transmission paths 51 and 61 are narrow, even if the passage 31 is adjacent to the wall 29 at a side opposite to the intrusion detection region of the wall 29, the person walking at the side of the vehicle 32 on the passage 31 hardly enters the detection area 27. Thus, the false detection caused by the vehicle 32 and the walking person on the passage 31 can be suppressed or prevented.

When a system is applied in which two cables of the transmitter leakage coaxial cable and the receiver leakage coaxial cable are aligned on the ground in a horizontal direction, which is a related-art standand installation method using the radiation leakage coaxial cables, an interval between the transmission leakage coaxial cable and the receiver leakage coaxial cable needs to be 80 cm or larger. Also, in order to avoid disturbance of the transmit and receive signal waves due to an object other than the intrusion object, it is desirable to make the leakage coaxial cables apart from a fixed peripheral structure by 50 cm or longer, and from a traveling vehicle by 5 m or longer. Therefore, a space 2 m to several m in width is required in the installation of the radiation leakage coaxial cable. In this case, the height of the detection area is about 2 m.

When there is applied the system in which two cables of the transmitter leakage coaxial cable and the receiver leakage coaxial cable are aligned on the ground in a horizontal direction, which is a related-art standard installation method using the surface wave leakage coaxial cables, an interval between the transmitter leakage coaxial cable and the receiver leakage coaxial cable is substantially the same as that in the case of the radiation type. However, because an arrival distance of the radio wave radiated toward outside of those cases is shorter, a space required for installation of the cable is about 1 m to 1.5 m in width. In the case of the surface wave type, because the arrival distance of the radio wave radiated in the vertical direction is also shorter, the height of the detection area is less than half that in the case of the radiation type. Thus, the detection performance for the intrusion object in the height direction is deteriorated. However, since the person walking on the ground is normally to be detected, the deterioration of the detection performance for the intrusion object in the height direction is not substantially remarkably problematic from the viewpoint of intrusion detection.

### Thirteenth Embodiment

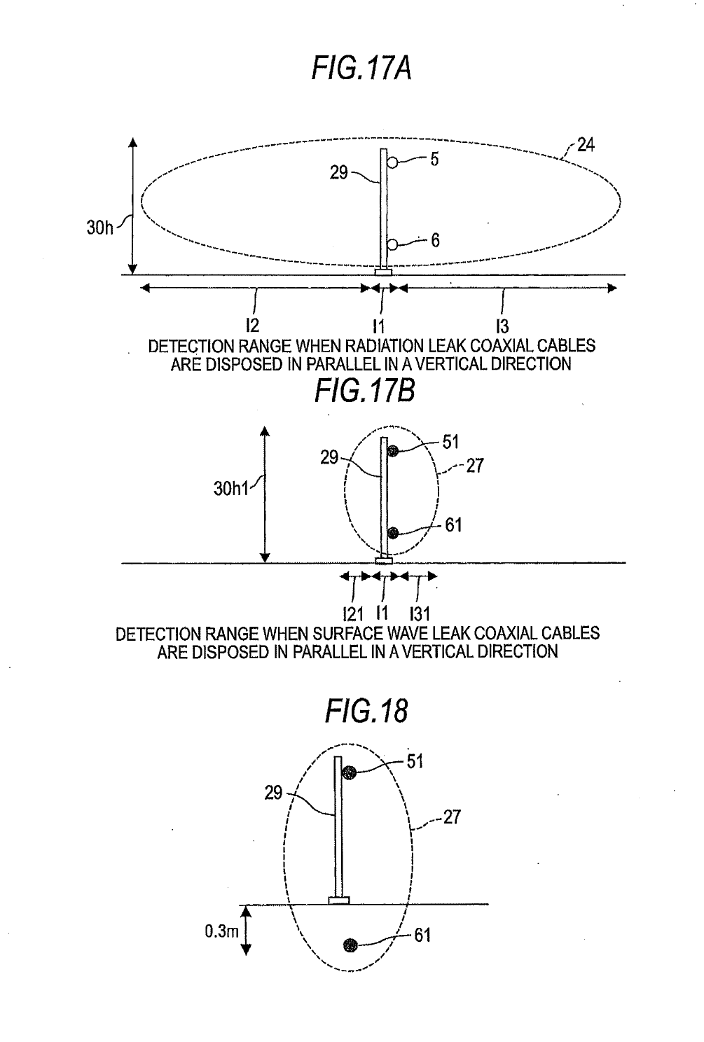

Hereinafter, a thirteenth embodiment of the present invention will be described with reference to FIGS. 17A and 17B.

In the thirteenth embodiment, as exemplified in FIG. 17B, the relative installation positional relationship between the surface wave transmitter leakage transmission path 51 and the surface wave receiver leakage transmission path 61 is a relationship in which the surface wave transmitter leakage transmission path 51 and the surface wave receiver leakage transmission path 61 are disposed in parallel perpendicularly along the wall 29. Also, at least one of the transmitter leakage transmission path 51 and the receiver leakage transmission path 61 is fitted to the intrusion detection region side of the wall 29. FIG. 17B typically illustrates a case in which both of the transmitter leakage transmission path 51 and the receiver leakage transmission path 61 are fitted to the wall 29 at the intrusion detection region side of the wall.

When the relative installation positional relationship between the transmitter leakage transmission path and the receiver leakage transmission path is a relationship in which the transmitter leakage transmission path and the receiver leakage transmission path are disposed in parallel perpendicularly along the wall 29, as illustrated in FIG. 17A, an intrusion can be detected even when both of the transmitter leakage transmission path 5 and the receiver leakage transmission path 6 are radiation leakage coaxial transmission paths. However, when both of the transmitter leakage transmission path 5 and the receiver leakage transmission path 6 are the radiation leakage coaxial transmission path, the detection area 24 is relatively large. Not only the detection height 30 h is higher than the detection height 30 h1 in the case of the surface wave leakage coaxial transmission paths 51 and 61 illustrated in FIG. 17B, but also the detection width is an installation width 11 between the leakage transmission paths 5 and 6 in the horizontal direction, and detection widths 12 and 13 outside the leakage transmission paths 5 and 6 in the horizontal direction, which is 11+12+13 in total. The total of the installation width 11 between the leakage transmission paths 51 and 61 in the horizontal direction in the case of the surface wave leakage coaxial transmission paths 51 and 61, and detection widths 121 and 131 outside the leakage transmission paths 51 and 61 in the horizontal direction is 11+121+131. A relationship between 11+12+13 and 11+121+131 becomes 11+12+13>11+121+131. As illustrated in FIG. 17B, 12>121 and 13>131 are satisfied.

That is, as contrastively illustrated in FIGS. 17A and 17B, the detection area 27 in the case of using the surface wave leakage coaxial transmission paths 51 and 61 is smaller than the detection area 24 in the case of using the radiation leakage coaxial transmission paths 5 and 6. Accordingly, when one or two of the two leakage coaxial cables used as the intrusion detecting system are the surface wave leakage coaxial cables, only an object in the vicinity of the cable can he detected without detecting an object at a position apart from the leakage coaxial cable. That is, the false detection can be suppressed.

Also, that the detection performance of the intrusion detecting system is not affected by the object at the position apart from the leakage coaxial cable means that an interval from the existing structure can be narrowed as an advantage from the viewpoint of the leakage coaxial cable installation.

### Fourteenth Embodiment

Hereinafter, a fourteenth embodiment of the present invention will be described with reference to FIG. 18.

In the fourteenth embodiment, as exemplified in FIG. 18, one (the transmitter leakage transmission path 51 in this embodiment) of the transmitter leakage transmission path 51 and the receiver leakage transmission path 61 is fitted to the wall 29 at the intrusion detection region side of the wall 29, and the other (the receiver leakage transmission path in this embodiment) of the transmitter leakage transmission path and the receiver leakage transmission path is embedded in the ground by a given depth.

According to this embodiment, the lower coaxial leakage transmission path 61 is prevented from being damaged when the intrusion object goes across the leakage transmission paths. Also, the intruder can be detected even if the intruder digs the ground, and passes through the wall 29 from underneath. Also, because one coaxial leakage transmission path 51 is exposed to the ground surface, a coercive pressure can be suppressed. Further, when the lower leakage transmission path is the radiation leakage coaxial transmission path 6, the detection area in the ground direction can be expanded, and walk-through from a deeper position can be detected.

### Fifteenth Embodiment

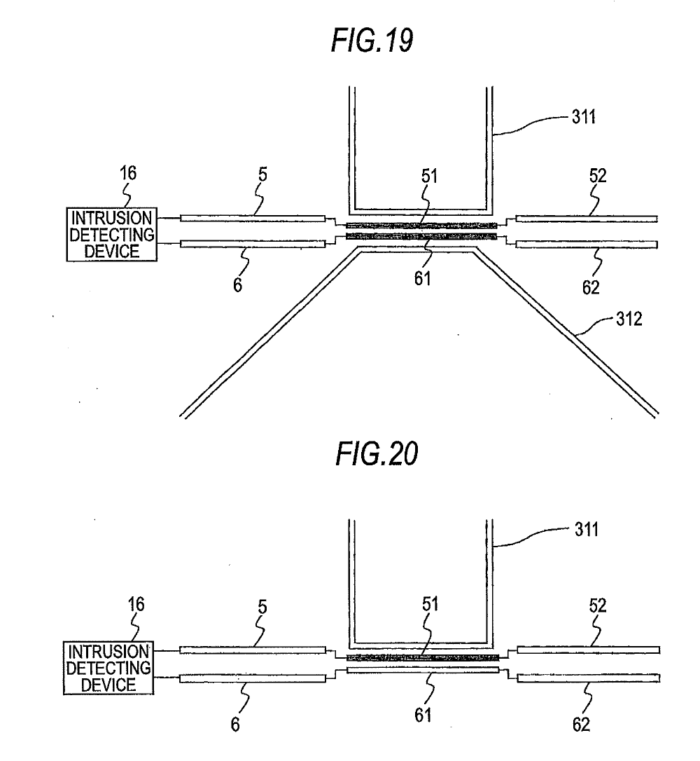

Hereinafter, a fifteenth embodiment of the present invention will be described with reference to FIG. 19.

In the fifteenth embodiment, as illustrated in FIG. 19, in a relatively large-scaled intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,

wherein each of the transmitter leakage transmission path and the receiver leakage transmission path is configured by coupling a plurality of the leakage coaxial transmission paths 5, 51, 52, 6, 61, and 62 in a longitudinal direction (extending direction) thereof,

wherein in the transmitter leakage transmission path and the receiver leakage transmission path each configured by coupling the plurality of the leakage coaxial transmission paths 5, 51, 52, 6, 61, and 62, the leakage transmission paths 51 and 61 adjacent to the passages 311 and 312 are surface wave leakage coaxial transmission paths, and

wherein the leakage transmission paths other than the leakage transmission paths 51 and 61 adjacent to the passages 311 and 312 are radiation leakage coaxial transmission paths 5, 52, and 62.

According to this embodiment, in the relatively large-scaled intrusion detecting system, in the region adjacent to the passages 311 and 312, the surface wave leakage coaxial transmission path is placed to prevent false detection. In the region not adjacent to the passages 311 and 312, the radiation leakage coaxial transmission path is placed, thereby realizing a system that can prevent false detection with an inexpensive system configuration.

### Sixteenth Embodiment

Hereinafter, a sixteenth embodiment of the present invention will be described with reference to FIG. 20.

In the sixteenth embodiment, when no passage 312 in FIG. 19 exists, as exemplified in FIG. 20, the leakage transmission path 51 at the side where the passage 311 exists is configured by the surface wave leakage coaxial transmission path, and the leakage transmission path 63 at the side where no passage exists is configured by the radiation leakage coaxial transmission path. With this configuration, false detection can be suppressed, and the inexpensive system configuration is provided.

In FIGS. 1 to 20, the identical symbols denote the same or corresponding parts.

Various modifications and alterations of this invention will be apparent to those skilled in the art without departing from the scope and spirit of this invention, and it should be understood that this is not limited to the illustrative embodiments set forth herein.

What is claimed is:

1. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein at least one of the transmitter leakage transmission path and the receiver leakage transmission path is a surface wave leakage coaxial transmission path.

2. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein at least one of the transmitter leakage transmission path and the receiver leakage transmission path is a surface wave leakage coaxial transmission path,
wherein one of the transmitter leakage transmission path and the receiver leakage transmission path extends at a lower side of a plurality of windows arranged laterally in a building over the plurality of windows,
wherein the other of the transmitter leakage transmission path and the receiver leakage transmission path extends at an upper side of the plurality of windows over the plurality of windows, and
wherein the intrusion detecting device detects from which of the plurality of windows the intrusion object intrudes on the basis of the change in the detection signal, which is detected by the receiver leakage transmission path.

3. The intrusion detecting system according to claim 2,
wherein a height of the plurality of windows is equivalent to a height of the intrusion object, and
wherein both of the transmitter leakage transmission path and the receiver leakage transmission path are surface wave leakage coaxial transmission paths.

4. The intrusion detecting system according to claim 3,
wherein both of the transmitter leakage transmission path and the receiver leakage transmission path are disposed outside the building.

5. The intrusion detecting system according to claim 3,
wherein both of the transmitter leakage transmission path and the receiver leakage transmission path are disposed inside the building.

6. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object. in the intrusion monitor area on the basis of a change in the detection signal received by the receiver leakage transmission path,
wherein at least one of the transmitter leakage transmission path and the receiver leakage transmission path is a surface wave leakage coaxial transmission path,
wherein one of the transmitter leakage transmission path and the receiver leakage transmission path extends at a left side of a plurality of windows arranged longitudinally in a building over the plurality of windows,
wherein the other of the transmitter leakage transmission path and the receiver leakage transmission path extends at a right side of the plurality of windows over the plurality of windows, and
wherein the intrusion detecting device detects from which of the plurality of windows the intrusion object intrudes on the basis of the change in the detection signal, which is received by the receiver leakage transmission path.

7. The intrusion detecting system according to claim 6,
wherein both of the transmitter leakage transmission path and the receiver leakage transmission path are disposed outside the building.

8. The intrusion detecting system according to claim 6,
wherein both of the transmitter leakage transmission path and the receiver leakage transmission path are disposed inside the building.

9. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein one of the transmitter leakage transmission path and the receiver leakage transmission path extends at a left side of a plurality of windows arranged longitudinally in a building over the plurality of windows,
wherein the other of the transmitter leakage transmission path and the receiver leakage transmission path extends at a right side of the plurality of windows over the plurality of windows,
wherein a height of a lower window of the plurality of windows is equivalent to a height of the intrusion object,
wherein both of the transmitter leakage transmission path and the receiver leakage transmission path at both of right and left sides of the lower window are surface wave leakage coaxial transmission paths,
wherein both of the transmitter leakage transmission path and the receiver leakage transmission path at both of right and left sides of a window upper than the lower window are radiation leakage coaxial transmission paths, and
wherein the intrusion detecting device detects from which of the plurality of windows the intrusion object intrudes on the basis of the change in the detection signal, which is received by the receiver leakage transmission path.

10. The intrusion detecting system according to claim 9,
wherein both of the transmitter leakage transmission path and the receiver leakage transmission path are disposed outside the building.

11. The intrusion detecting system according to claim 9,
wherein both of the transmitter leakage transmission path and the receiver leakage transmission path are disposed inside the building.

12. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein both of the transmitter leakage transmission path and the receiver leakage transmission path are surface wave leakage coaxial transmission paths,
wherein one of the transmitter leakage transmission path and the receiver leakage transmission path extends at one side of a passage inlet,
wherein the other of the transmitter leakage transmission path and the receiver leakage transmission path extends at the other side of the passage path with respect to the inlet, and
wherein the intrusion detecting device detects that the intrusion object intrudes from the passage inlet on the basis of the change in the detection signal, which is received by the receiver leakage transmission path.

13. The intrusion detecting system according to claim 12,
wherein both of the transmitter leakage transmission path and the receiver leakage transmission path are disposed outside a wall of the passage inlet.

14. The intrusion detecting system according to claim 12,
wherein both of the transmitter leakage transmission path and the receiver leakage transmission path are disposed inside a wall of the passage inlet.

15. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein one of the transmitter leakage transmission path and the receiver leakage transmission path extends at one side of a passage inlet,
wherein the other of the transmitter leakage transmission path and the receiver leakage transmission path extends at the other side of the passage path with respect to the inlet,
wherein in an area where a height of the leakage transmission paths at both sides of the passage inlet is equal to a height of the intrusion object, both of the leakage transmission paths at both sides thereof are surface wave leakage coaxial transmission paths,
wherein in an area where a height of the leakage transmission paths at both sides of the passage inlet is equivalent to or higher than the height of the intrusion object, both of the leakage transmission paths at both sides are radiation leakage coaxial transmission paths, and
wherein the intrusion detecting device detects that the intrusion object intrudes from the passage inlet on the basis of the change in the detection signal, which is received by the receive leakage transmission path.

16. The intrusion detecting system according to claim 15,
wherein both of the surface wave leakage coaxial transmission path and the radiation leakage coaxial transmission path are disposed outside a wall of the passage inlet.

17. The intrusion detecting system according to claim 15,
wherein both of the surface wave leakage coaxial transmission path and the radiation leakage coaxial transmission path are disposed inside a wall of the passage inlet.

18. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein the transmitter leakage transmission path and the receiver leakage transmission path are placed at an intrusion detection region side of a wall close to the wall, and
wherein both of the transmitter leakage transmission path and the receiver leakage transmission path are surface wave leakage coaxial transmission paths.

19. The intrusion detecting system according to claim 18,
wherein a relative installation positional relationship between the transmitter leakage transmission path and the receiver leakage transmission path are a relationship in which the transmitter leakage transmission path and the receiver leakage transmission path are disposed in parallel to a horizontal direction along the wall.

20. The intrusion detecting system according to claim 18,
wherein a relative installation positional relationship between the transmitter leakage transmission path and the receiver leakage transmission path are a relationship in which the transmitter leakage transmission path and the receiver leakage transmission path are disposed in parallel to a vertical direction along the wall.

21. The intrusion detecting system according to claim 20,
wherein at least one of the transmitter leakage transmission path and the receiver leakage transmission path is fitted to the wall at the intrusion detection region side of the wall.

22. The intrusion detecting system according to claim 20,
wherein one of the transmitter leakage transmission path and the receiver leakage transmission path is fitted to the wall at the intrusion detection region side of the wall, and
wherein the other of the transmitter leakage transmission path and the receiver leakage transmission path is embedded in the ground by a given depth.

23. An intrusion detecting system in which a transmitter leakage transmission path that transmits a detection signal for detecting an intrusion and a receiver leakage transmission path that receives the detection signal leaked from the transmitter leakage transmission path are installed apart from each other within an intrusion monitor area, and an intrusion detecting device detects presence or absence of an intrusion object in the intrusion monitor area on the basis of a change in the detection signal received by the receiver leakage transmission path,
wherein each of the transmitter leakage transmission path and the receiver leakage transmission path is configured by coupling a plurality of the leakage coaxial transmission paths,
wherein in the transmitter leakage transmission path and the receiver leakage transmission path each configured by coupling the plurality of the leakage transmission paths, the leakage transmission paths adjacent to the passage are surface wave leakage coaxial transmission paths, and
wherein the leakage transmission paths other than the leakage transmission paths adjacent to the passage are radiation leakage coaxial transmission paths.
